(19) United States
(12) Patent Application Publication
(10) Pub. No.: US 2009/0099280 A1
(43) Pub. Date: Apr. 16, 2009

(54) Acrylated Polyaminoamide (I)

(75) Inventor: Antoine Carroy, Marlioz (FR)

Correspondence Address: FOX ROTHSCHILD LLP, 2000 MARKET STREET, PHILADELPHIA, PA, 19103, US

(73) Assignee: COGNIS IP MANAGEMENT GMBH, Duesseldorf (DE)

(21) Appl. No.: 12/252,172

(22) Filed: Oct. 15, 2008

Related U.S. Application Data
(60) Provisional application No. 60/979,883, filed on Oct. 15, 2007.

(51) Int. Cl. C08F 2/46; C08G 63/91; C08G 73/06

(52) U.S. Cl. 522/173; 525/451; 525/421; 525/417

(57) ABSTRACT

Acrylated polyaminoamides obtainable by Michael addition of polyaminoamides containing terminal amine groups (A) and polyolester acrylates (B) which contain at least 8 acrylate groups per molecule, the molar ratio of the acrylate groups in the polyolester acrylates (B) to the aminohydrogen groups in the polyaminoamides (A) being at least 8:1, are suitable as radiation-curable compounds for the production of coatings.

### RELATED APPLICATIONS

The present application is related to and claims the priority benefit of provisional application 60/979,883, filed Oct. 15, 2007, which is incorporated herein in its entirely by reference as if fully set forth.

### FIELD OF THE INVENTION

This invention relates to special acrylated polyaminoamides and to their use for radiation-curable coatings.

### BACKGROUND AND RELATED ART

Acrylated amines were proposed some time ago as radiation-curable compounds for coating purposes. U.S. Pat. No. 3,963,771 (Union Carbide, 1976) discloses reaction products of acrylate esters with primary or secondary organic amines.

Coating compositions based on polyester (meth)acrylates and polyamines containing primary or secondary amino groups, the two compounds being reacted substantially stoichiometrically with one another, were also proposed more than 20 years ago in EP 231 442 A2 (PCI Polymerchemie, 1986).

EP 0 002 801 B1 discloses binders consisting of at least two compulsory components, namely (1) a vinyl addition polymer containing several primary or secondary amine groups which are attached to units in the polymer chain and (2) a material containing at least two acryloxy groups (Rohm & Haas, 1978).

U.S. Pat. No. 6,706,821 describes Michael addition products of amine-terminated polyolefins and polyfunctional acrylates.

DE 103 04 631 A1 describes light-sensitive resin compositions of the negative type. These compositions are Michael addition products of special polyamines with (bifunctional) polyethylene glycol di(meth)acrylates.

EP 0 002 457 B1 (Rohm & Haas, 1978) describes solid polyaminoester polymers comprising two units, namely (1) acrylate ester monomers with a functionality of at least 2.5 and (2) aliphatic amine monomers with a molecular weight of ≦1,000 and an NH equivalent weight of <100, the acrylate:NH equivalent ratio having to be in the range from 0.5 to 2.

U.S. Pat. No. 4,975,498 (Union Camp) describes heat-curable aminoamide acrylate polymers.

EP 381 354 B1 (Union Camp) describes a bonding process using a radiation-curable acrylate-modified aminoamide resin which is the Michael addition product of a thermoplastic aminoamide polymer having an amine value of more than 1 and less than 100 with a polyolester containing a number of acrylate ester groups (polyolester acrylate). The ratio of the original acrylate groups of the polyol ester to the original aminohydrogen groups of the aminoamide polymer is greater than 0.5 and less than 8. Michael addition is understood here to be the addition of an NH group onto a C═C group. It is clear from the specification of EP 381 354 B1 that the acrylate:NH ratio mentioned is meant to be understood as a product-by-process definition (cf. in particular page 3, lines 2-8; page 3, lines 53-56 and page 4, lines 15-31).

According to the later EP 505 031 A2 in the name of the same applicant, the Michael addition is carried out by reacting a mixture of aminoamide polymer and an NH-containing reactive diluent with the polyolester acrylate. According to WO 93/15151 (Union Camp), the Michael addition is carried out in aqueous dispersion.

A later application, WO 01/53376 A1 (Arizona Chemical Comp.), describes aminoamide acrylate polymers with a very special structure which can be obtained by Michael addition of special resin mixtures with multifunctional acrylate esters (for example TMP triacrylate).

U.S. Pat. No. 6,809,127 B2 (Cognis Corp.) describes liquid-radiation curable compositions containing the reaction product of an amine-terminated polyaminoamide and a mono- or polyacrylate.

WO 06/067639 A2 (Sun Chemical) describes radiation-curable acrylate-modified aminoamide resins. These resins are Michael adducts of thermoplastic aminoamide polymers—derived from polymerized unsaturated fatty acids (for example dimer fatty acids)—and polyolesters containing at least three acrylate groups per molecule. According to the document in question, the aminoamide polymer must have an amine value of 40 to 60 and the ratio of the original acrylate groups in the polyolester to the original amino groups of the aminoamide polymer must be at least 4:1.

WO 07/030643 A1 (Sun Chemical) uses Michael adducts of polyolester acrylates with polyaminoamides for printing inks, the polyaminoamide being the reaction product of a polyamine with an acid component, with the proviso that this acid component contains two compulsory constituents, namely (a) a polymerized unsaturated fatty acid (for example dimer fatty acid) and (b) a fatty acid containing 2 to 22 carbon atoms.

### DETAILED DESCRIPTION OF PREFERRED EMBODIMENTS

As the documents discussed in the foregoing show, radiation-curable acrylated polyaminoamides on the one hand have a certain tradition, on the other hand there is a constant demand for improvements. In this context, the problem addressed by the present invention was to provide new radiation-curable acrylated polyaminoamides. These polyaminoamides would be suitable for coating purposes in general and for printing inks, preferably offset printing inks, in particular.

The present invention relates to radiation-curable acrylated polyaminoamides obtainable by Michael addition of polyaminoamides containing terminal amine groups (A) and polyolester acrylates (B) which contain at least 8 acrylate groups per molecule, the molar ratio of the acrylate groups in the polyolester acrylates (B) to the aminohydrogen groups in the polyaminoamides (A) being at least 8:1. The expression “acrylate groups” in the context of the present invention is meant to encompass both acrylate groups and methacrylate groups and is used in the interests of terminological simplification.

In consistency with the prior art cited above, Michael addition is understood to be the addition reaction of an amino group onto an activated C═C double bond (typically of an ester). Formally, this may be expressed by the following reaction equation:

NH+C=CC(O)->NC—CHC(O)

Such reactions generally take place spontaneously in the event of moderate heating. However, catalysts may also be used to accelerate the Michael addition.

Although, strictly speaking, this type of reaction would be better described as a “Michael-analogous” reaction, the handier term “Michael addition” used in the patent literature cited above is retained in the present specification. This is because it is clear to the expert what is meant by the term which, in any case, is defined in the foregoing.

As mentioned above, the compounds (A) and (B) are used for the production of the radiation-curable acrylated polyaminoamides according to the invention by Michael addition. These compounds are described in more detail in the following:

### Compounds (A)

The compounds (A) are polyaminoamides with terminal amine groups. These terminal amine groups may be primary or secondary, i.e. NH₂ or NH groups. Otherwise there are basically no limitations as to the nature of the polyaminoamides.

The polyaminoamides (A) used are preferably compounds which can be obtained by reacting
carboxylic acids containing 2 to 54 carbon atoms per molecule and two COOH groups per molecule (i.e. dicarboxylic acids) and
diamines containing 2 to 36 carbon atoms.

In one embodiment, the dicarboxylic acids are selected from the group of dimer fatty acids, aliphatic α,ω-dicarboxylic acids containing 2 to 22 carbon atoms and dibasic aromatic carboxylic acids containing 8 to 22 carbon atoms.

Dimer fatty acids are preferably used as the dicarboxylic acids. As the expert is aware, dimer fatty acids are carboxylic acids obtainable by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—technical-quality dimer fatty acids—are mixtures in which the dimerization products predominate. However, the product mixture also contains small amounts of monomers (the sum total of monomers in the crude mixture of the dimer fatty acids is referred to by the expert as monomer fatty acids) and higher oligomers, more especially the so-called trimer fatty acids. Dimer fatty acids are commercially available products and are available in various compositions and qualities (for example under the name of Empol®, a product of the applicant).

In one embodiment, the dicarboxylic acids used are α,ω-dicarboxylic acids containing 2 to 22 carbon atoms, more particularly saturated dicarboxylic acids of this type. Examples include ethane dicarboxylic acid (oxalic acid), propane dicarboxylic acid (malonic acid), butane dicarboxylic acid (succinic acid), pentane dicarboxylic acid (glutaric acid), hexane dicarboxylic acid (adipic acid), heptane dicarboxylic acid (pimelic acid), octane dicarboxylic acid (suberic acid), nonane dicarboxylic acid (azelaic acid), decane dicarboxylic acid (sebacic acid), undecane dicarboxylic acid, dodecane dicarboxylic acid, tridecane dicarboxylic acid (brassylic acid), tetradecane dicarboxylic acid, pentadecane dicarboxylic acid, hexadecane dicarboxylic acid (thapsic acid), heptadecane dicarboxylic acid, octadecane dicarboxylic acid, nonadecane dicarboxylic acid, eicosane dicarboxylic acid.

In another embodiment, the dicarboxylic acids used are dibasic aromatic carboxylic acids containing 8 to 22 carbon atoms, for example isopthalic acid.

Another embodiment is characterized by the use of mixtures of various dicarboxylic acids, for example dimer fatty acid in admixture with at least one acid from the group of α,ω-dicarboxylic acids containing 2 to 22 carbon atoms.

As already mentioned, the diamines on which the polyaminoamides (A) are based are selected in particular from the group of diamines containing 2 to 36 carbon atoms. Examples of suitable diamines are ethylene diamine, hexamethylene diamine, diaminopropane, piperazine, aminoethyl piperazine, 4,4′-dipiperidine, toluene diamine, methylene dianiline, xylene diamine, methyl pentamethylene diamine, diaminocyclohexane, polyether diamine and diamines produced from dimer acid. The diamines are selected in particular from the group consisting of ethylene diamine, hexamethylene diamine, diaminopropane, piperazine and aminoethyl piperazine. Piperazine and aminoethyl piperazine are most particularly preferred.

### Compounds (B)

The compounds (B) are polyolester acrylates which contain at least 8 acrylate groups per molecule.

It is expressly pointed out here that, in the context of the present specification, the expression “acrylate groups” encompasses both acrylate groups and methacrylate groups. In addition, the expression “acrylic acid” also encompasses the expression “methacrylic acid”.

The polyolester acrylates may be produced by esterification of polyols containing at least 8 OH groups per molecule with acrylic acid and/or methacrylic acid, the esters preferably being full esters, i.e. all OH groups of the polyols are esterified with acrylic or methacrylic acid. It is also expressly pointed out that, instead of the polyols, addition products thereof with ethylene and/or propylene oxide may also be used.

One embodiment is characterized by the use of polyolester acrylates (B) which contain at least 9 acrylate groups per molecule. Polyolester acrylates (B) containing 9 to 18 acrylate groups per molecule are particularly preferred.

In another embodiment, hyperbranched polymers are used as the polyolester acrylates (B). Examples of hyperbranched polymers (B) are those which are obtainable from the Sartomer Company (for information on these compounds, see, for example, the publication by Jeffrey A. Klang entitled “Radiation Curable Hyperbranched Polyester Acrylates”: RadTech e/5 2006 Technical Proceedings) and which are selected from the group of compounds known commercially as CN 2300 (acrylate functionality 8), CN 2301 (acrylate functionality 9), CN 2302 (acrylate functionality 16) and CN 2304 (acrylate functionality 18).

In another embodiment, dendritic polymers (dendrimers) are used as the polyolester acrylates (B). Examples of dendritic polymers (B) are those which are obtainable from the Perstorp company and which are selected from the group of compounds known commercially as “Boltorn H2300 Acrylate”, “Boltorn P1000 Acrylate” and “Boltorn H20 Acrylate”. If desired, corresponding polyolester acrylates (B) may also be produced by converting Perstorp dendritic polyols into acrylates or methacrylates. Examples of suitable Perstorp dendritic polyols which may be used for the synthesis of polyolester acrylates (B) are “Boltorn H2003” (hydroxyfunctionality 12), “Boltorn P1000” (hydroxyfunctionality 14), “Boltorn H20” (hydroxyfunctionality 16), “Boltorn H30” (hydroxyfunctionality 32), “Boltorn H40” (hydroxyfunctionality 64) and “Boltorn P500” (hydroxyfunctionality 19).

If desired, polyolester acrylates (B) may also be produced by converting dendritic polyols known commercially as “Hybrane” (DSM Hybrane BV), for example by reaction with acrylic acid. These dendritic polyols of the “Hybrane” type have terminal OH groups which can be converted into the corresponding polyolester acrylates (B) with acrylic acid.

As mentioned above, the polyolester acrylates (B) are compounds with—based on the acrylate groups—a high functionality (8 or higher). In this connection, it is pointed out that there is a difference in polymer architecture between star polymers (linkage of linear chain molecules to a focal point) and cascade polymers. Cascade polymers are divided into dendrimers and hyperbranched polymers:
Dendrimers (from the Greek “dendros”, meaning “tree”) are chemical compounds of which the structure is branched similarly to a tree, the compounds being called dendrimers where these branches consist of repetitive units. Accordingly, starting out from a core, dendrimers must incorporate a branch, otherwise a chain would be obtained. There may be one branch to two or even more linkage points. Dendrimers are distinguished by a strictly asymmetrical structure. Their degree of branching is 100% and they have a precise, defined molecular weight. Accordingly, dendrimers have a perfectly branched structure with radial symmetry. The shells lying around the core are also known as generations. The dendrimer skeleton has three regions: the core, the inner branching units and the periphery with terminal groups.
So-called hyperbranched polymers are not dendrimers. Rather, hyperbrached polymers are irregularly branched and are obtained by statistical polymerization of monomers (by condensation or addition reactions). Accordingly, hyperbranched polymers have a branching statistic and the molecules have no centrosymmetrical topology.

The fact that hyperbranched polymers can be used as the polyolester acrylates (B) was mentioned in the foregoing, more particularly with reference by way of example to actual compounds commercially available from the Sartomer Company. However, dendrimers may also be used as polyolester acrylates (B).

The present invention also relates to radiation-curable coating compositions containing a crosslinkable compound and a photoinitiator, the crosslinkable compound containing at least one acrylated polyaminoamide. All the foregoing observations apply in regard to the acrylated polyaminoamide. In a preferred embodiment, these compositions are compositions which additionally contain a pigment and which, hence, are printing inks. Corresponding compositions are preferably used for offset printing.

What is claimed is:

1. A radiation-curable acrylated polyaminoamide obtainable by Michael addition of polyaminoamides containing terminal amine groups (A) and polyolester acrylates (B) which contain at least 8 acrylate groups per molecule, the molar ratio of the acrylate groups in the polyolester acrylates (B) to the aminohydrogen groups in the polyaminoamides (A) being at least 8:1.

2. The acrylated polyaminoamide of claim 1, wherein said polyaminoamides (A) are compounds obtainable by reaction of dicarboxylic acids and diamines, the dicarboxylic acids being selected from the group consisting of dimer fatty acids, α,ω-dicarboxylic acids containing 2 to 22 carbon atoms and aromatic dicarboxylic acids containing 8 to 22 carbon atoms, and the diamines being selected from the group of diamines containing 2 to 36 carbon atoms.

3. The acrylated polyaminoamide of claim 1, wherein the diamines on which the polyaminoamides (A) are based are selected from the group consisting of ethylenediamine, hexamethylene diamine, diaminopropane, piperazine and aminoethyl piperazine.

4. The acrylated polyaminoamide of claim 1, wherein the dicarboxylic acids on which the polyaminoamides (A) are based are selected from the group of dimer fatty acids.

5. The acrylated polyaminoamide of claim 1, wherein said polyolester acrylates (B) contain at least 9 acrylate groups per molecule.

6. The acrylated polyaminoamide of claim 5, wherein hyperbranched polymers are used as the polyolester acrylates.

7. The acrylated polyaminoamide of claim 6, wherein said hyperbranched polymers are selected from the group consisting of Sartomer products CN C2301 (acrylate functionality 9), C2302 (acrylate functionality 16) and C 2394 (acrylate functionality 18).

8. A radiation-curable coating composition containing a crosslinkable compound and a photoinitiator, wherein the crosslinkable compound contains at least one acrylated polyaminoamide according to claim 1.

9. The composition of claim 8, further containing a pigment, wherein said composition is useful as a printing ink.

10. A method of offset printing comprising using the composition of claim 9 for offset printing.
